(19) United States
(12) Patent Application Publication
(10) Pub. No.: US 2012/0306435 A1
(43) Pub. Date: Dec. 6, 2012

(54) CHARGING CIRCUIT WITH UNIVERSAL SERIAL BUS PORT

(75) Inventors: YI-XIN TU, Shenzhen City (CN); HAI-QING ZHOU, Shenzhen City (CN); JIN-LIANG XIONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/239,415

(22) Filed: Sep. 22, 2011

(30) Foreign Application Priority Data
Jun. 3, 2011 (CN) 201110148822.0

(51) Int. Cl. H02J 7/00

(52) U.S. Cl. 320/107

(57) ABSTRACT

A charging circuit includes a switch, a standby power supply, a first power supply, a second power supply, a universal serial bus (USB) port, and a power supply switching module with a first to a fourth terminals. According to the power states of a computer, the power supply switching module allows either a first power supply or a second standby power supply to provide a charging voltage for the USB port through controlling the switch.

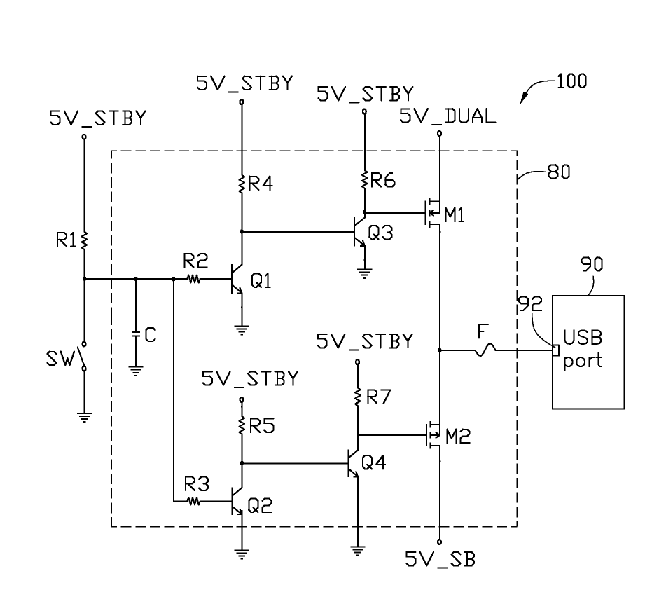

### BACKGROUND

1. Technical Field

The present disclosure relates to a charging circuit having a universal serial bus (USB) port.

2. Description of Related Art

Electronic devices with USB ports, such as mobile telephones or digital cameras, can be charged through a USB port of a computer. However, the USB port of the computer cannot supply a charging voltage when the computer operates at the S5 state where the computer is soft off.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments.

The FIGURE is a circuit diagram of an exemplary embodiment of a charging circuit.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

Referring to the FIGURE, an exemplary embodiment of a charging circuit 100 includes a switch SW, a resistor R1, a power supply switching module 80, and a universal serial bus (USB) port 90 with a power terminal 92.

A first terminal of the switch SW is connected to a standby power supply 5V_STBY through the resistor R1, and a second terminal of the switch SW is grounded.

The switching module 80 includes a first terminal connected to the first terminal of the switch SW, a second terminal connected to a dual power supply 5V_DUAL, a third terminal connected to a standby power supply 5V_SB, and a fourth terminal connected to the power terminal 92. When the switch SW is turned off, the first and the second terminals of the switch SW are disconnected. The standby power supply 5V_STBY outputs a voltage to the first terminal of the switching module 80 to allow the dual power supply 5V_DUAL to output a voltage to the power terminal 92. When the switch SW is turned on, the first and the second terminals of the switch SW are connected. The first terminal of the switching module 80 is grounded, which allows the standby power supply 5V_SB to output a voltage to the power terminal 92.

In this embodiment, the switching module 80 includes transistors Q1-Q4 (e.g. NPN transistors), an n-channel metal oxide semiconductor field-effect transistor (MOSFET) M1, a p-channel MOSFET M2, resistors R2-R7, a capacitor C, and a fuse F. A first terminal of the capacitor C functions as the first terminal of the power supply switching module 80. A base of the transistor Q1 is connected to the first terminal of the capacitor C through the resistor R2. A base of the transistor Q2 is connected to the first terminal of the capacitor C through the resistor R3. A second terminal of the capacitor C is grounded. Emitters of the transistors Q1 and Q2 are grounded. A collector of the transistor Q1 is connected to the standby power supply 5V_STBY through the resistor R4. A collector of the transistor Q2 is coupled to the standby power supply 5V_STBY through the resistor R5.

Abase of the transistor Q3 is connected to the collector of the transistor Q1. A base of the transistor Q4 is connected to the collector of the transistor Q2. Emitters of the transistors Q3 and Q4 are grounded. A collector of the transistor Q3 is connected to the standby power supply 5V_STBY through the resistor R6. A collector of the transistor Q4 is connected to the standby power supply 5V_STBY through the resistor R7. A gate of the MOSFET M1 is connected to the collector of the transistor Q3. A gate of the MOSFET M2 is connected to the collector of the transistor Q4. A source of the MOSFET M1 functions as the second terminal of the power supply switching module 80. A drain of the MOSFET M1 is connected to a source of the MOSFET M2 and a first terminal of the fuse F. A second terminal of the fuse F functions as the fourth terminal of the switching module 80. A drain of the MOSFET M2 functions as the third terminal of the switching module 80.

When the computer operates at the S0 state where the computer system is on, the S1 state (power-on suspend), the S2 state where the central processing unit is powered off, or the S3 state (suspend to random-access memory), the standby power supply 5V_STBY and the dual power supply 5V_DUAL are on, while the standby power supply 5V_SB is off. The first and the second terminals of the switch SW are disconnected manually. The standby power supply 5V_STBY outputs a voltage to the bases of the transistors Q1 and Q2, thereby turning on the transistors Q1 and Q2. The bases of the transistors Q3 and Q4 are grounded through the transistors Q1 and Q2, respectively, to receive a low-level signal. The transistors Q3 and Q4 are turned off. The standby power supply 5V_STBY outputs a voltage to the gates of the MOSFETs M1 and M2 to turn on the MOSFET M1, and to turn off the MOSFET M2. The dual power supply 5V_DUAL outputs a voltage to the power terminal 92 through the MOSFET Q5 to provide a charging voltage for the USB port 90.

When the computer operates at the S4 state (suspend to disk) or S5 state where the computer is soft off, the standby power supplies 5V_STBY and 5V_SB are on, while the dual power supply 5V_DUAL is off. The first and the second terminals of the switch SW are connected manually. The bases of the transistors Q1 and Q2 are grounded through the switch SW to receive a low-level signal. The transistors Q1 and Q2 are turned off. The standby power supply 5V_STBY outputs a voltage to the bases of the transistors Q3 and Q4 to turn on the transistors Q3 and Q4. The gates of the MOSFETs M1 and M2 are grounded through the transistors Q3 and Q4, respectively. The MOSFET M1 is turned off, while the MOSFET M2 is turned on. The standby power supply 5V_SB outputs a voltage to the power terminal 92 to provide a charging voltage for the USB port 90.

In other embodiments, the transistors Q1-Q4 and the MOSFETs M1-M2 can be replaced by other types of transistors or other electronic components with electronic switch function.

The foregoing description of the exemplary embodiments of the disclosure has been presented only for the purposes of illustration and description and are not intended to be exhaustive or to limit the disclosure to the precise forms disclosed. Many modifications and variations are possible. The embodiments were chosen and described in order to explain the principles of the disclosure and their practical application so as to enable others of ordinary skill in the art to utilize the disclosure and various embodiments and with such various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A charging circuit comprising:
a switch comprising a first terminal connected to a first standby power supply through a first resistor, and a second terminal grounded;
a universal serial bus (USB) port comprising a power terminal; and
a power supply switching module comprising a first terminal connected to the first terminal of the switch, a second terminal connected to a first power supply, a third terminal connected to a second standby power supply, and a fourth terminal connected to the power terminal of the USB port, wherein when the first and the second terminals of the switch are disconnected, the first standby power supply outputs a voltage to the first terminal of the power supply switching module to allow the first power supply to provide a first charging voltage for the USB port, when the first and the second terminals of the switch are connected, the first terminal of the power supply switching module is grounded to allow the second standby power supply to provide a second charging voltage for the USB port.

2. The charging circuit of claim 1, wherein the first power supply is a dual 5-volt power supply.

3. The charging circuit of claim 1, wherein the power supply switching module comprises a second to a fifth resistors, a capacitor, and a first to a sixth electronic switches each of which comprises a first to a third terminals, a first terminal of the capacitor functions as the first terminal of the power supply switching module, the first terminals of the first and the second electronic switches are connected to the first terminal of the capacitor, a second terminal of the capacitor is grounded, the second terminal of the first electronic switch is connected to the first standby power supply through the second resistor, the second terminal of the second electronic switch is connected to the first standby power supply through the third resistor, the third terminals of the first and the second electronic switches are grounded; the first terminal of the third electronic switch is connected to the second terminal of the first electronic switch, the first terminal of the fourth electronic switch is connected to the second terminal of the second electronic switch, the second terminal of the third electronic switch is connected to the first standby power supply through the fourth resistor, the second terminal of the fourth electronic switch is connected to the first standby power supply through the fifth resistor, the third terminals of the third and fourth electronic switches are grounded; the first terminal of the fifth electronic switch is connected to the second terminal of the third electronic switch, the first terminal of the sixth electronic switch is connected to the second terminal of the fourth electronic switch, the second terminal of the fifth electronic switch functions as the second terminal of the power supply switching module, the third terminal of the fifth electronic switch is connected to the second terminal of the sixth electronic switch, and further connected to the power terminal of the USB port, the third terminal of the sixth electronic switch functions as the third terminal of the power supply switching module.

4. The charging circuit of claim 3, further comprising a fuse, wherein a first terminal of the fuse is connected to the third terminal of the fifth electronic switch, a second terminal of the fuse functions as the fourth terminal of the power supply switching module.

5. The charging circuit of claim 4, wherein the first to the fourth electronic switches are transistors, the first to the third terminals of the first to the fourth electronic switches are bases, collectors, and emitters of the transistors, respectively.

6. The charging circuit of claim 4, wherein the fifth electronic switch is an n-channel metal oxide semiconductor field-effect transistor (MOSFET), the sixth electronic switch is a p-channel MOSFET, the first to the third terminals of the fifth and the sixth electronic switches are gates, sources, and drains of the MOSFETs, respectively.

7. The charging circuit of claim 3, wherein the power supply switching module further comprises a sixth and a seventh resistors, the sixth resistor is connected between the first terminal of the first electronic switch and the first terminal of the switch, the seventh resistor is connected between the first terminal of the second electronic switch and the first terminal of the switch.
